(19) United States
(12) Patent Application Publication
(10) Pub. No.: US 2016/0137293 A1
(43) Pub. Date: May 19, 2016

(54) ENCLOSED DRONE APPARATUS AND METHOD FOR USE THEREOF

(71) Applicant: Skypersonic, Bloomfield Hills, MI (US)

(72) Inventor: Giuseppe Santangelo, Troy, MI (US)

(73) Assignee: Skypersonic, Bloomfield Hills, MI (US)

(21) Appl. No.: 14/265,386

(22) Filed: Apr. 30, 2014

Related U.S. Application Data
(60) Provisional application No. 61/890,992, filed on Oct. 15, 2013.

(51) Int. Cl. B64C 25/00; B64C 39/02; B64C 27/08

(52) U.S. Cl. CPC B64C 25/00; B64C 27/08; B64C 39/024; B64C 2201/024; B64C 2201/146

(57) ABSTRACT

An unmanned aerial vehicle apparatus (100) that includes an air vehicle assembly (150) that is at least partially enclosed within a protective enclosure assembly (120) The protective enclosure assembly (120) is typically at least partially elastic, to protect the air vehicle assembly (150) from bumps, collisions, and other similar occurrences. The enclosure assembly (120) can also facilitate the ability of the apparatus (100) to operate in a ground movement mode (114), such as a rolling mode (116), in addition to a flying mode (112).

### RELATED APPLICATIONS

This U.S. utility patent application claims priority to and incorporates by reference the entirety of U.S. provisional patent application titled “SphereCopter—A Spherical Quad Copter Drone” (Ser. No. 61/890,992) filed on Oct. 15, 2013.

### BACKGROUND OF THE INVENTION

The invention relates generally to unmanned vehicles capable of flight. Such vehicles are commonly referred to as unmanned aerial vehicles (“UAVs”), or less formally as “drones”. The invention is an enclosed drone apparatus, and a method for using such a device.

Drones were originally developed for use by the military in the context of special operations. The technology has spread to civilian applications such as policing, firefighting, and security. Many are predicting that the developed world is on the cusp of a dramatic revolution in the use of drones for non-governmental use. Quartz (www.qz.com) published an article in January 2013 titled “[t]he private drone industry is like Apple in 1984.”

There are good reasons to conclude that drone technology may soon impact the daily lives of everyday consumers. Amazon CEO Jeff Bezos dominated the headlines during the busy Christmas shopping season of 2013 when he announced that Amazon was testing drone technology as a potential delivery system for some Amazon products. In February 2014, the www.aviationpros.com website in February 2014 publicized two reports predicting a global drone market of $8.35 billion by 2018 and $114.7 billion by 2023.

In response to the anticipated wide-spread adoption of drone technology, the Federal Aviation Administration (“FAA”) issued a “road map” on Nov. 7, 2013 that identified technical, regulatory, and procedural issues that would need to be overcome for the widespread integration of drones into commercial airspace. Numerous state legislatures have enacted or are considering the enactment of laws addressing privacy and safety concerns pertaining to the proper use of drones. The National Conference of State Legislatures

In anticipation of a burgeoning governmental and private markets for drones, there are significant ongoing efforts to improve drone technology in certain respects. Unfortunately, these efforts ignore a fundamental way of protecting bystanders and the drone itself. The prior art does teach or suggest positioning the drone within an enclosure that can protect the outside world from the drone, and the drone from the outside world.

### SUMMARY OF THE INVENTION

The invention relates generally to unmanned vehicles capable of flight. Such vehicles are commonly referred to as unmanned aerial vehicles (“UAVs”), or less formally as “drones”. The invention is an enclosed drone apparatus, and a method for using such a device.

The apparatus can include a vehicle assembly that is located within an enclosure component. A wide range of different vehicle assemblies can be incorporated into the apparatus. Potentially any prior art vehicle assembly can benefit by being enclosed within an enclosure component.

The enclosure component can protect the vehicle assembly from being damaged by the environment of the apparatus. The enclosure component can also protect the persons and property in the environment of the apparatus from being damaged by the vehicle assembly.

The enclosure component can also enable the apparatus to operate in a rolling mode in addition to a flight mode.

### BRIEF DESCRIPTION OF THE DRAWINGS

Different examples of various attributes and components that can be incorporated into the apparatus and methods for using the apparatus are illustrated in the drawings described briefly below. No patent application can expressly disclose in words or in drawings, all of the potential embodiments of an invention. In accordance with the provisions of the patent statutes, the principles, functions, and modes of operation of the apparatus are illustrated in certain preferred embodiments. However, it must be understood that the apparatus may be practiced otherwise than is specifically illustrated without departing from its spirit or scope.

FIG. 1a is a block diagram illustrating an example of different types of components that can make up an apparatus.

FIG. 1b is a hierarchy diagram illustrating an example of different types of operating modes.

FIG. 1c is a block diagram illustrating an example of a user interacting with the apparatus.

FIG. 1d is a hierarchy diagram illustrating an example of the different types of enclosure assemblies.

FIG. 1e is a block diagram illustrating an example of the different types of components that can make up an enclosure assembly.

FIG. 1f is a block diagram illustrating an example of the different types of components that can make up a vehicle assembly.

FIG. 1g is a block diagram illustrating an example of the different types of components that can make up the frame.

FIG. 1h is a block diagram illustrating an example of the different types of components that can serve as supplemental components for the apparatus.

FIG. 2a is a perspective diagram illustrating an example of an apparatus.

FIG. 2b is a top view diagram illustrating an example of an apparatus.

FIG. 2c is a bottom view diagram illustrating an example of an apparatus.

FIG. 2d is a side view diagram illustrating an example of an apparatus.

FIG. 3a is side view diagram illustrating an example of an enclosure assembly.

FIG. 3b is a side view diagram illustrating an example of an enclosure assembly.

FIG. 3c is a perspective view diagram illustrating an example of an enclosure assembly that is not curved.

FIG. 4a is a perspective view diagram illustrating an example of an air vehicle assembly.

FIG. 4b is a top view diagram illustrating an example of a frame.

FIG. 4c is a top view diagram illustrating an example of a frame.

FIG. 4d is a top view diagram illustrating an example of a frame.

FIG. 4e is a top view diagram illustrating an example of a frame.

FIG. 4f is a top view diagram illustrating an example of a frame.

FIG. 4g is a top view diagram illustrating an example of a frame.

FIG. 4h is a top view diagram illustrating an example of a frame.

FIG. 5a is a top view diagram illustrating an example of an apparatus.

FIG. 5b is a side view diagram illustrating an example of an apparatus in a rolling operating mode.

FIG. 5c is a side view diagram illustrating an example of how an apparatus can be steered while in a rolling mode.

FIG. 6a is a flow chart diagram illustrating an example of a rolling operating mode.

FIG. 6b is a flow chart diagram illustrating an example of an apparatus switching back and forth between various operating modes.

### DETAILED DESCRIPTION

The invention relates generally to unmanned vehicles capable of flight. Such vehicles are commonly referred to as unmanned aerial vehicles (“UAVs”), or less formally as “drones”. The invention is an enclosed drone apparatus, and a method for using such a device.

### I. Overview

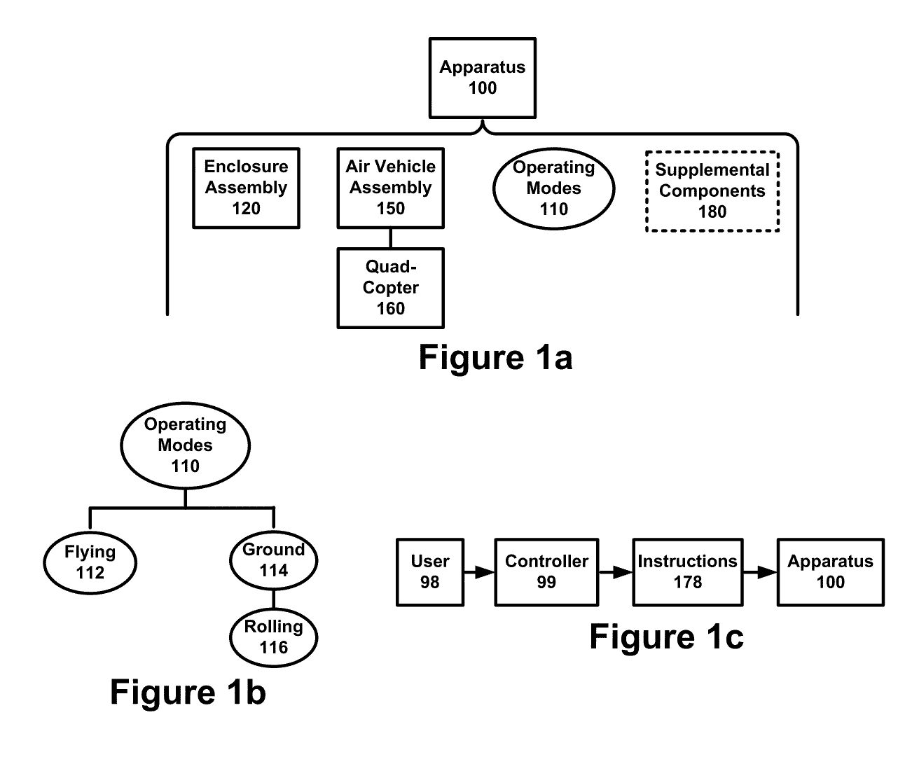

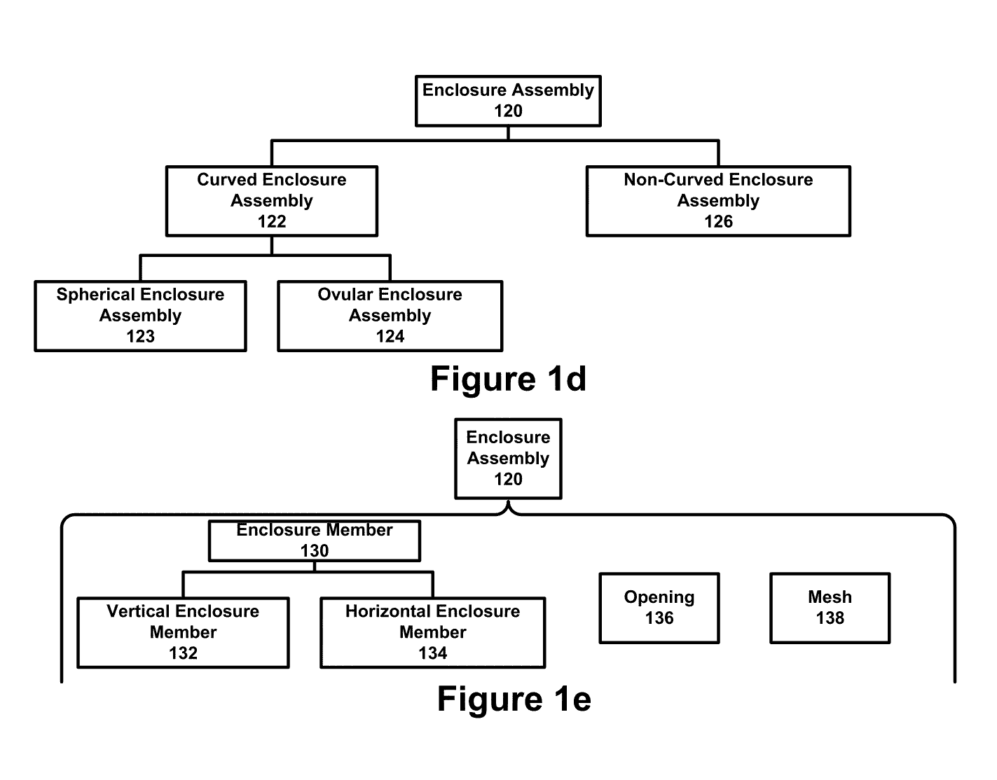

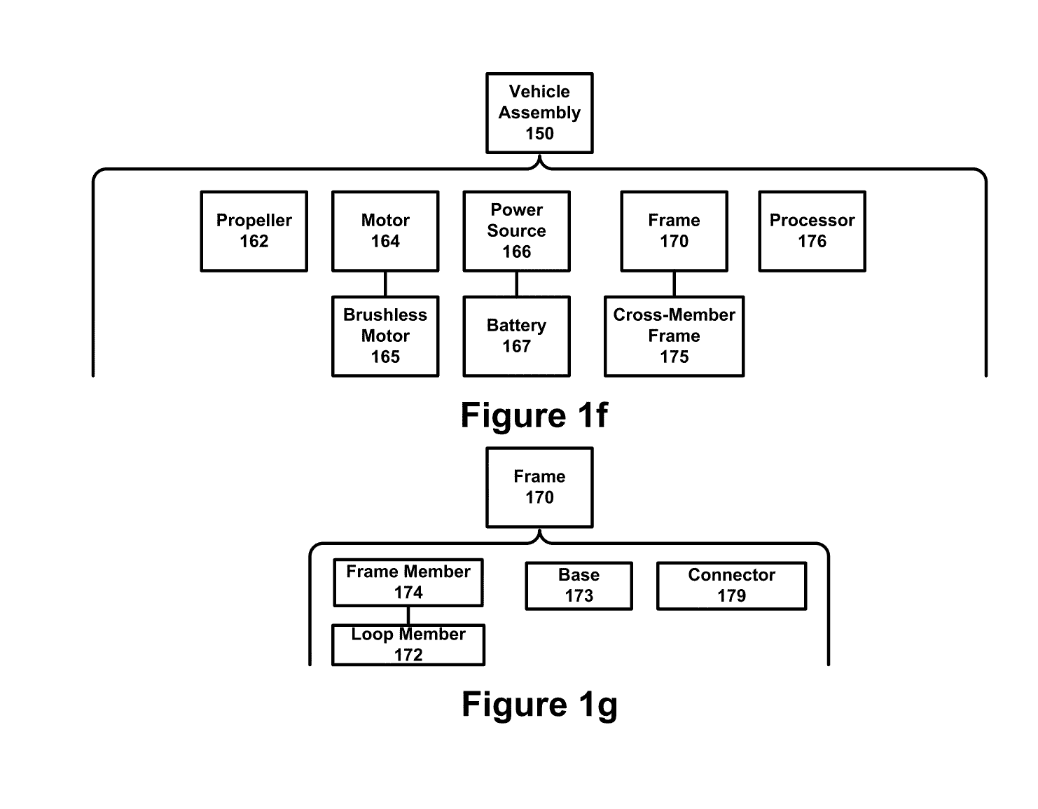

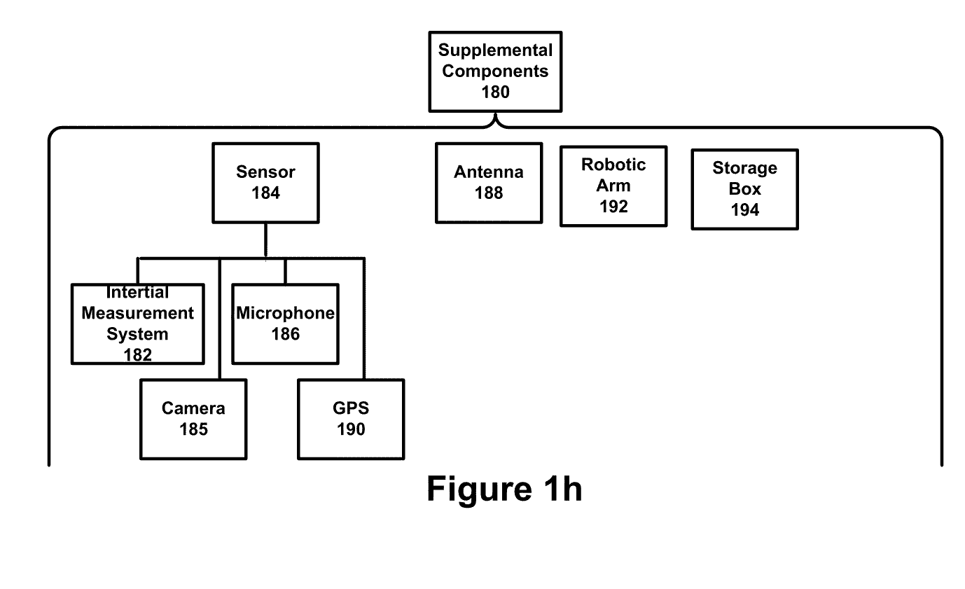

FIG. 1a is a block diagram illustrating an example of different types of components that can make up an apparatus 100. The apparatus 100 can be comprised of air vehicle assembly 150 is enclosed within an enclosure assembly 120. Many different types of drones currently known in the prior art or developed in the future can be incorporated as an air vehicle assembly 150 for the apparatus 100. The apparatus 100 can use a wide variety of different enclosure assemblies 120.

A. Protection/Safety Advantages from an Enclosed UAV

The apparatus 100 can be described as a drone or unmanned aerial vehicle (“UAV”) that operates within a protective enclosure. The enclosure assembly 120 can protect the air vehicle assembly 150 from the operating environment of the apparatus 100 and the operating environment of the apparatus 100 from the air vehicle assembly 150.

There are many reasons to be enthusiastic about the possibilities presented by drone technology. However, there are also a variety of negative of implications to many drone designs. Any device capable of powered movement is going to present some risk of accidents that injure people, property, and the drone device itself. UAVs operate in accordance with instructions provided via remote control, instructions provided prior to use, and/or autonomous algorithms/heuristics. Some level of accident risk is inevitable. Thus it can also be helpful to reduce the negative consequences of accidents/collisions as well as reducing the risk of accidents/collisions.

Such risks are particularly prevalent in the context of air travel. UAVs typically involve one or more propellers rotating rapidly. Collisions between propellers and the world external to the UAV can damage the external environment as well as the drone. A damaged propeller can cause a UAV to crash to the ground, potentially causing property damage, personal injuries, and even death.

Users and bystanders alike can benefit when an air vehicle assembly 150 is protected in an enclosure assembly 120. The air vehicle assembly 150 can be completely, substantially, or even partially enclosed by the enclosure assembly 150. The enclosure assembly 120 can vary widely with respect to its elasticity. Different functions and operating environments can merit different air vehicle assembly 150 attributes and enclosure assembly 120 attributes.

Protecting the air vehicle assembly 150 during the landing process can be particularly beneficial. So can the ability of user to change the operating mode of the apparatus from air-based movement to ground-based movement.

B. Multiple Operating Modes—New Operational Opportunities

By enclosing an air vehicle assembly 150 within an enclosure assembly 120, entirely new operating modes 110 can be created. FIG. 1b is a hierarchy diagram illustrating an example of different types of operating modes 110. The apparatus 100 can potentially be implemented in such a manner as to possess two or more distinct operating modes 110. For example, the apparatus 100 can provide for flight (a flying operating mode 112), ground (a driving operating mode 114), and potentially operating modes 110 pertaining to water, whether on or below the surface of the water. Different embodiments may involve multiple propulsion means pertaining to a single type of operating mode 110. For example, an apparatus 100 could be configured to fly like a plane as well as like a helicopter.

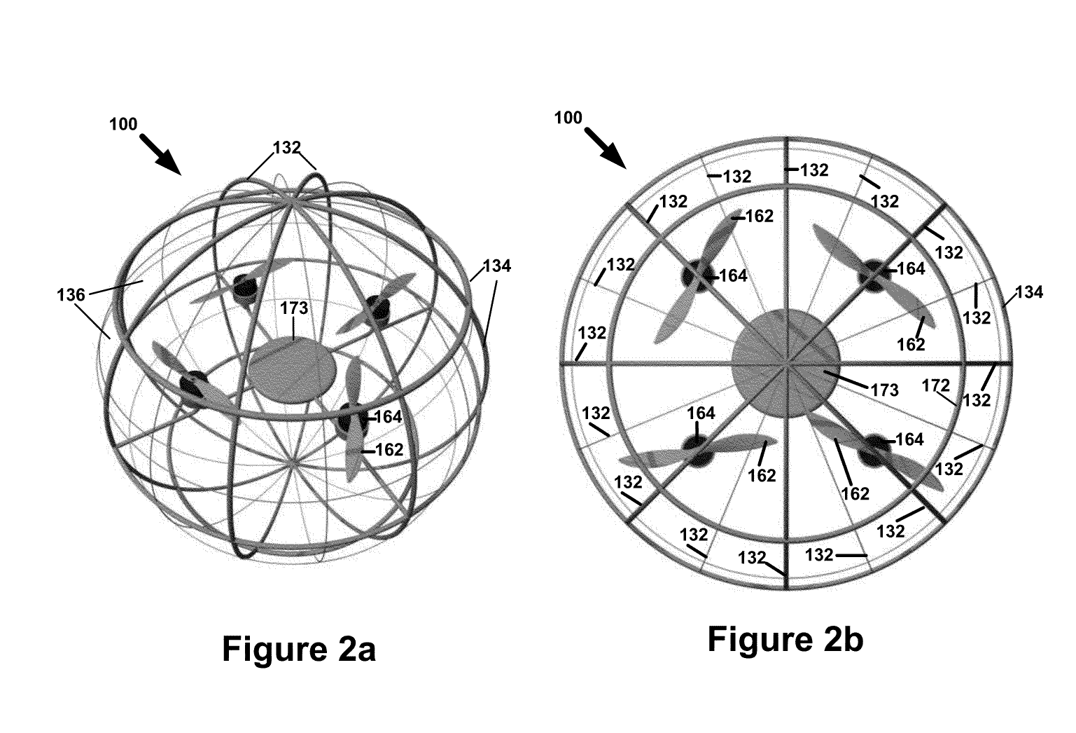

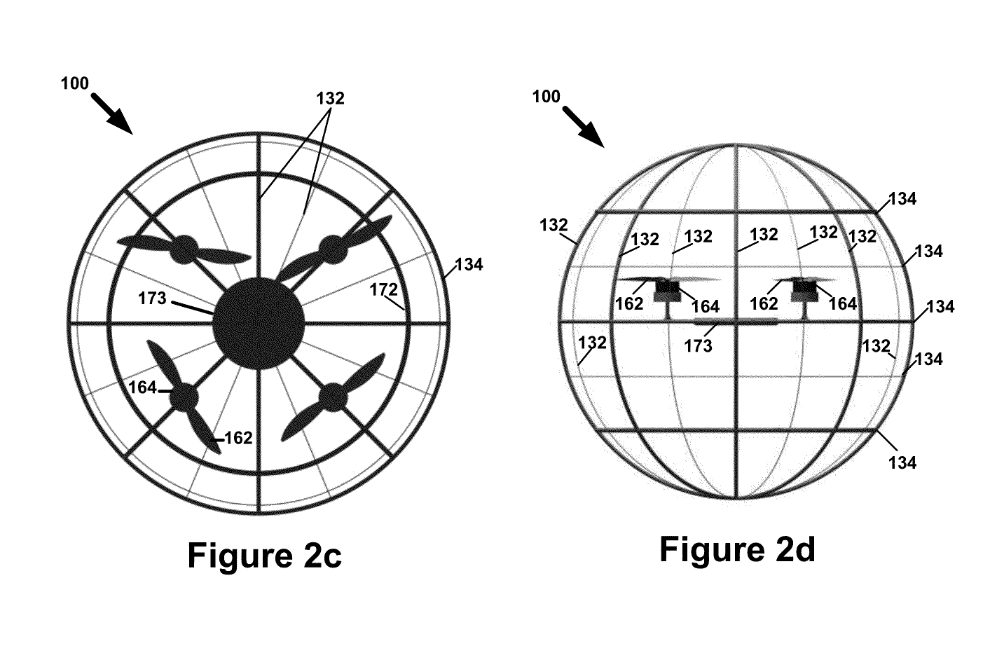

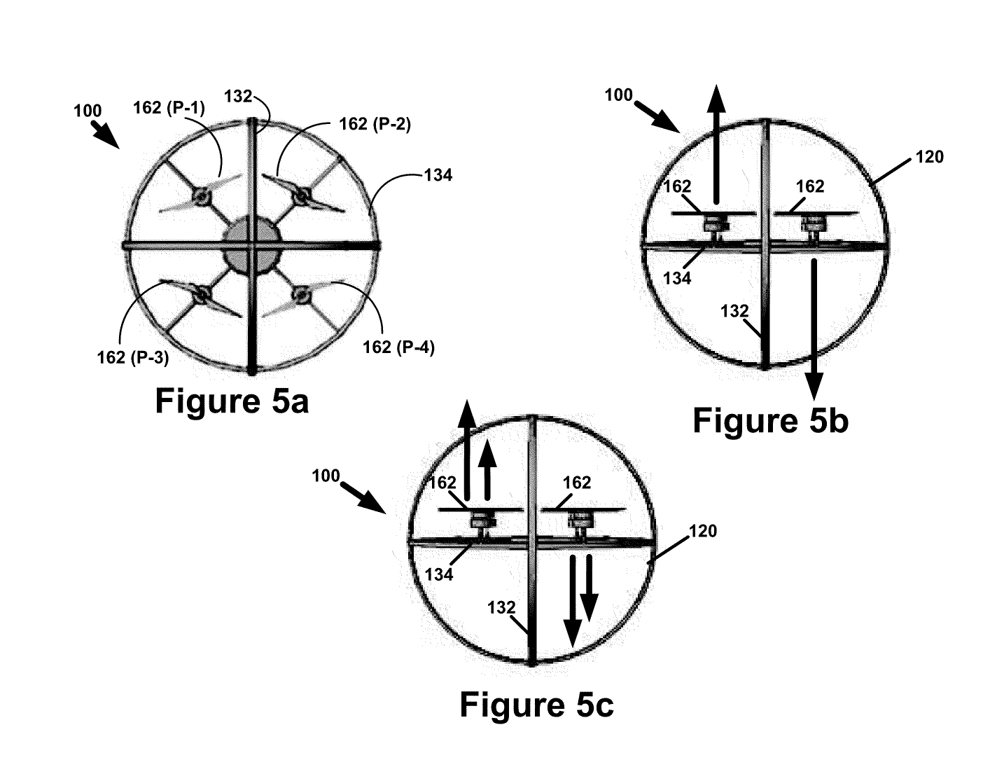

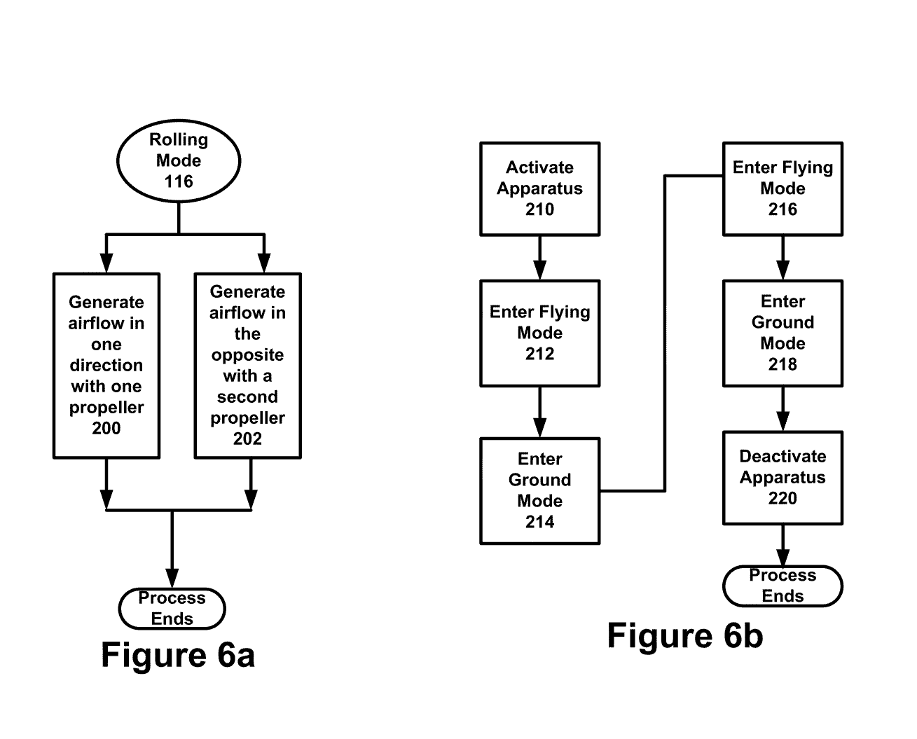

One example of a potential ground mode 114 is a rolling mode 116. An example of an apparatus 100 intended to provide users with the option of a rolling mode 116 is illustrated in FIGS. 2a-2d. The process for enabling an otherwise flight-worthy apparatus 100 to roll on the ground is illustrated in FIG. 5a-6b. Enclosing the air vehicle assembly 150 facilitates the ability of users to utilize the apparatus 100 on the ground as well as in the air. The apparatus 100 can travel through pipes and other hard-to access locations by providing users with the option to operate the apparatus 100 in a ground mode 114, such as a rolling mode 116.

Another potential ground mode 114 implementation can involve moving on the ground by using, by way of example only, an asymmetric mass that will move coordinately and continuously the barycenter of the apparatus 100 to trigger continuous rolling.

Additional types of ground modes 114 can be implemented in different embodiments of the apparatus 100. For example, in many contexts it is both anticipated and desirable for the apparatus 100 to encounter obstacles on the ground. The apparatus 100 can include a slipping or jumping mode as a type of ground movement mode 114. When an obstacle is detected or encountered, such as a stone, step or a gap or if in a narrow space like a pipe or a cave, the apparatus 100 will benefit by the enclosed protection of the enclosure assembly 120. The elasticity of the enclosure assembly 120 coupled with a jumping and/or slipping mode as a type of ground mode 114 can enhance the ability of the apparatus to move in the direction and path is designed or commanded to go.

C. Applications

It is anticipated that different apparatuses 100 will be configured for different types of contexts. The general capabilities of the apparatus 100 have a wide range of potential uses.

The apparatus 100 can be implemented as a toy or entertainment indoor/outdoor model. The enclosure assembly 120, particularly in a spherical shape 123, is safe to fly at home with a low risk of damage to things or injury to kids since the propeller 162 is not accessible with the hands. The elasticity in the bumps will prevent any damage. Such an embodiment can include additional padding for the enclosure assembly 120.

In the context of agriculture, the apparatus 100 can be used to monitor the fields and prevent plants from diseases.

The apparatus 100 can be used in wide variety of different inspection contexts, including tall buildings, bridges, and even plant inspection. The capability to move inside pipes as well as fly (reaching pipes in high positions) makes the apparatus 100 highly desirable in many contexts.

### II. Control of the Apparatus

FIG. 1c is a block diagram illustrating an example of a user 98 interacting with the apparatus 100. The controller 99 is the means by which a user 98 can submit instructions 178 to the apparatus 100.

A. User

A user 98 is not part of the apparatus 100. A user is typically a human being responsible for the operating of the apparatus 100. In some embodiments of the apparatus 100, the user can be information technology system, a robot, an expert system, some type of artificial intelligence component, or other similar form of a non-human user

B. Controller

A controller 99 is not part of the apparatus 100. A controller 99 is a mechanism by which instructions are submitted to the apparatus 100. In many contexts, the controller 99 is a wireless remote control unit or a device that includes the capability to create instructions 178 and then deliver the instructions 178 to the apparatus 100. Some embodiments of such a controller 99 can also be configured to receive feedback information from the apparatus 100.

Some embodiments of the apparatus 100 will function 100% on the basis of remote control instructions 178. Instructions 178 can be submitted to the apparatus 100 in one or more of the following different ways: (1) via remote control in real-time as the apparatus 100 operates; (2) via the controller 99 prior to the then current operation of the vehicle (pre-programmed); and/or (3) on-going algorithms/heuristics for “autonomous” action enabled within the apparatus 100.

C. Instructions

An instruction 178 is any form of information or communication that can be received by the apparatus 100 and used, selectively or otherwise, to impact the motion and operation of the apparatus 100. Instructions 178 can include direct commands that pertain to the immediate movement of the apparatus 100, but the instructions 178 can include software, information, and other operating parameters that impact the apparatus 100 beyond its then-present operations.

### III. Introduction of Elements

As illustrated in FIG. 1a and as discussed above, the apparatus 100 is comprised of two subsidiary assemblies, an enclosure assembly 120 (the portion of the apparatus that encloses the drone) and an air vehicle assembly 150 (the drone that is enclosed within the protective enclosure).

A. Enclosure Assembly

The enclosure assembly 120 can be comprised of a wide variety of different materials and configured in a wide variety of different shapes.

1. Different Types of Enclosure Assemblies

FIG. 1d is a hierarchy diagram illustrating an example of the different types of enclosure assemblies 120 distinguished by shape.

### a. Curved Enclosure Assemblies

Some enclosure assemblies are referred to as curved enclosure assemblies 122 because those assemblies 120 have at last some curved surfaces. Examples of curved enclosure assemblies 122 include a spherical enclosure assembly 123, an ovular enclosure assembly 124, a cylindrical enclosure assembly, and other variations pertaining to shape. A spherical enclosure 123 is entirely or at least substantially spherical in shape. An ovular enclosure assembly 124 is entirely or at least substantially ovular in shape. Curved enclosure assemblies 122 need not be entirely curved or continuous curved. However, the nature of curves can enhance the ability of the apparatus 100 to function in a rolling mode 116. Examples of curved enclosure assemblies are illustrated in FIGS. 2a-i b.

### b. Non-Curved Enclosure Assemblies

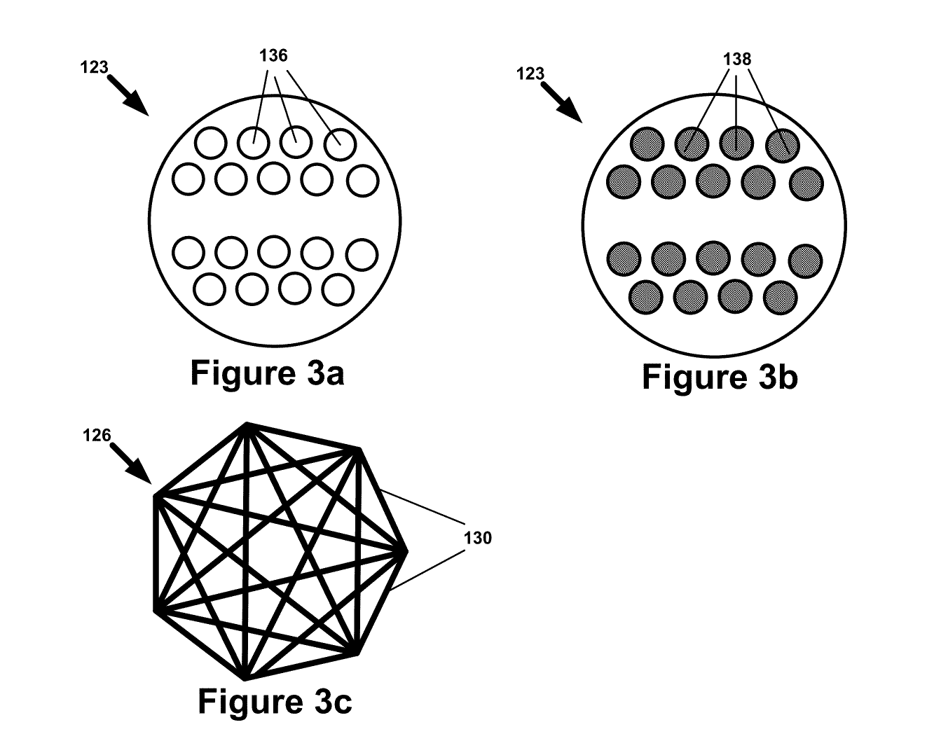

Returning to FIG. 1d, non-curved enclosure assemblies 126 do not have any curved edges. Examples of non-curved enclosure assemblies 126 can include icosahedrons, dodecagons, icosagons, tricontagons, tetracontagons, penacontagons, hexcontagons, and other known polygon and other geometrical configurations. An example of a non-curved enclosure assembly 126 is illustrated in FIG. 3c. Non-curved enclosure assemblies 126 can include the capability of operating in a rolling mode 116.

2. Enclosure Assembly Components

FIG. 1e is a block diagram illustrating an example of the different types of components that can make up an enclosure assembly 120.

### a. Enclosure Member

An enclosure member 130 is a portion of the surface of enclosure assembly 120. Enclosure members 130 are not typically air permeable. The air flow required for the movement function generated by propellers 162 is provided by one or more openings 136 in the enclosure assembly 120.

### i. Vertical Enclosure Member

An enclosure member 130 that possesses a vertical or substantially vertical orientation within the enclosure assembly 120. A vertical enclosure member 132 can also be referred to a vertical member 132. Vertical enclosure members 132 are illustrated in FIGS. 2a-2d.

### ii. Horizontal Enclosure Member

An enclosure member 130 that possess a horizontal or substantially horizontal orientation within the enclosure assembly 120. A horizontal enclosure member 134 can also be referred to as a horizontal member 134. Horizontal enclosure members 132 are illustrated in FIGS. 2a-2d.

### b. Opening

An area in the surface of the enclosure assembly 120 that is air permeable. Openings 136 can be shaped in a wide variety of different geometries and configurations. In some embodiments, the openings 136 are simply spaces between members 130 or other totally vacant space in the surface of the enclosure assembly 120. In other embodiments, openings 136 are covered by a mesh 138. The opening 136 can also be referred to as an enclosure opening 136. Examples of openings 136 are illustrated in FIGS. 2a-2d and 3a-3c, although the openings in 3b are covered with a mesh 138

### c. Mesh/Filter

A screen, filter, or similar material that covers the opening 136 but nonetheless allows air to flow in and out of the enclosure 120. An example of a mesh 138 is illustrated in FIG. 3b.

B. Air Vehicle Assembly

The parts of the apparatus 100 that provide for the powered movement of the apparatus 100 are collectively referred to as the air vehicle assembly 150. Virtually any type of drone in the prior art (helicopter, plane, hybrid, other, etc.) can potentially benefit from being enclosed within an enclosure assembly 120.

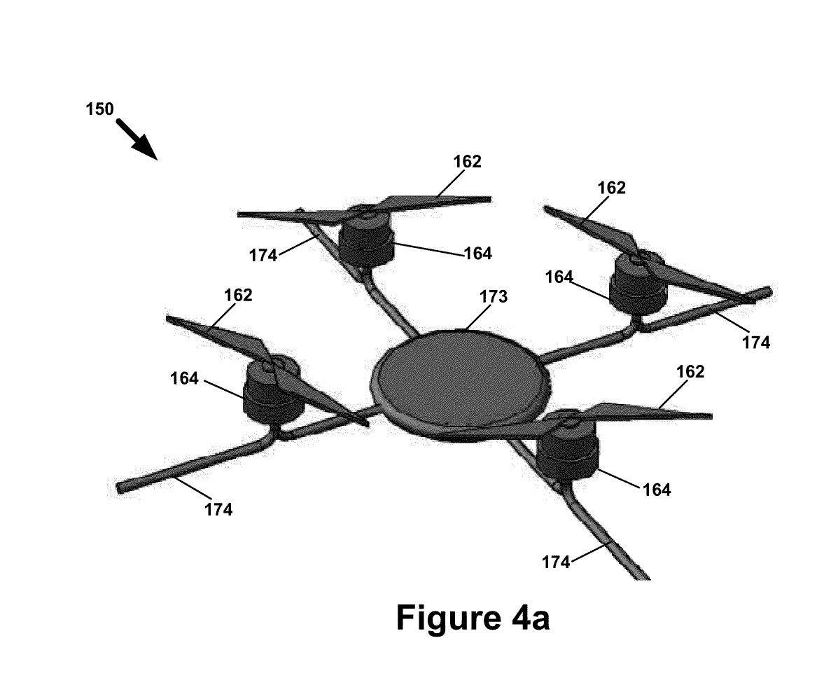

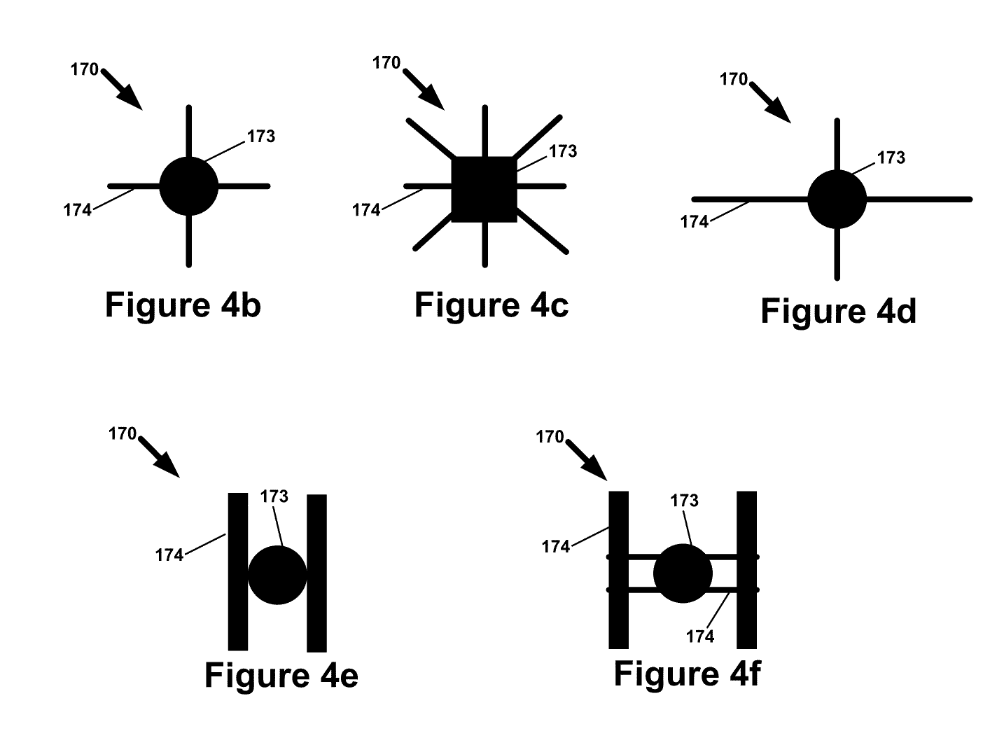

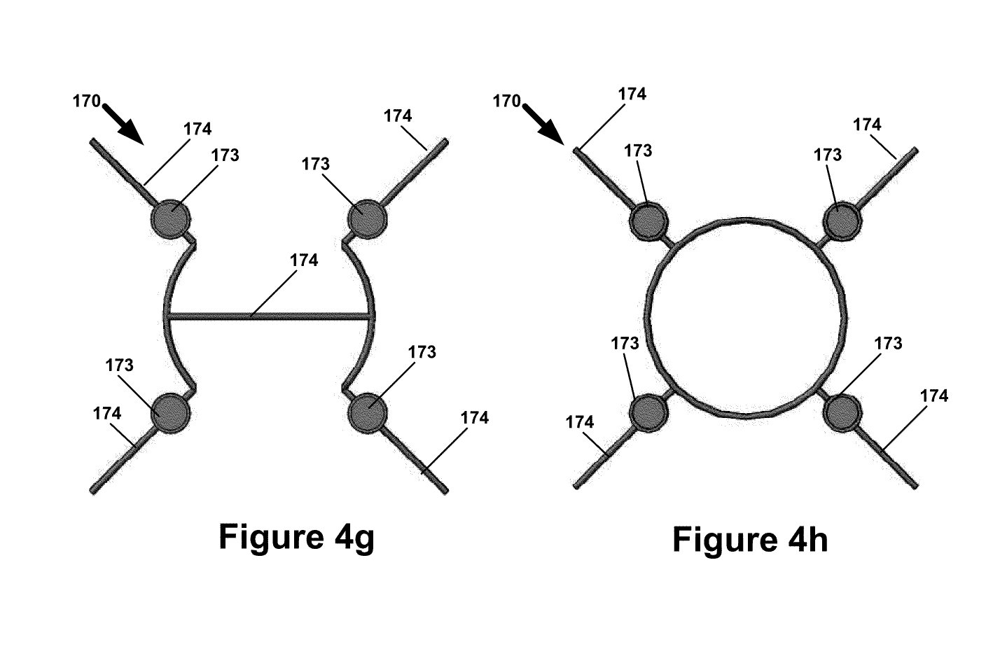

One category of air vehicle assembly 150 embodiments that is believed to be particularly useful is an quad-copter 160 which is identified in FIG. 1a and illustrated in FIGS. 2a-2d and 4a. Although the quad-copter 160 embodiment of the vehicle assembly 150 was the original inspiration for the inventive apparatus 100, there are a high magnitude of variation and customization that can be incorporated into the air vehicle assembly 150 for the apparatus 100.

FIG. 1f is a block diagram illustrating an example of the different types of components that can make up a vehicle assembly 150.

1. Propeller

The apparatus 100 will include one or more propellers 162. A propeller 162 is a component that propels the apparatus 100. Many embodiments include four or more propellers 162 because multiple propellers can assist in steering the vehicle in various operating modes 110. Some embodiments may include jet or rocket propulsion for use in addition to propellers 162 while in flight mode 112. A propeller 162 can direct airflow upwards or downwards when it spins.

The propellers 162 are the propulsion system for the air vehicle assembly 150 and the apparatus 100 as a whole. In a preferred quad-copter 160 embodiment, there are four symmetrical propellers162 acted on by brushless motors 165.

The driver control is designed to drive each propeller 162 in dual mode, obtaining direct and inverse thrust necessary for the rolling mode 116.

2. Motor

A motor 162 is a device that causes the propeller 162 to turn. Virtually any motor 162 used for a prior art drone can be incorporated as a motor 164 for the apparatus 100. Multiple propeller 162 embodiments will typically involve multiple motors 164. Many embodiments of the apparatus 100 will include a motor 164 that is a brushless motor 165.

3. Power Source

A power source 166 is any source of energy that can power the motor 164. Power sources can be batteries 167 (of different types), solar cells, and other power sources known in the prior art.

A battery 167 is a device that allows for energy to be stored for future use. A wide variety of different batteries 167 can be incorporated into the apparatus 100.

4. Frame

A frame 170 is a physical structure within the vehicle assembly 140 that serves to secure the position of many other components within the enclosure assembly 120. Many but not all frames 170 will be cross-member frames 175, a frame 170 that involves intersecting perpendicular members.

### a. Frame Members

FIG. 1g is a block diagram illustrating an example of the different types of components that can make up the frame. Frames 170, which can be referred to frame members 172. In some embodiments, frame members 172 will be formed in the shape of loops and can be referred to as loop members 172.

### b. Base

Frames 170 can also include a base 173 to support/hold virtually any other component of the apparatus 100, but in particular a computer processor 176 or a variety of supplemental components 180 that are discussed below. The geometry of a frame 170 can vary widely, just as the geometry of an enclosure assembly 120 can vary widely. FIGS. 4b-4h illustrate examples of frames 170 that can be incorporated into the apparatus 100.

By securing the position of many components of the air vehicle assembly 150 relative to the frame 170, the frame also servers to secure the position of those components with respect to the enclosure assembly 120 and the apparatus 100 as a whole.

### c. Connectors

A variety of different connectors 179 can either permanently or temporarily secure the frame 170 to the enclosure assembly 120. The frame 170 can be temporarily or permanently secured in the proper position within the enclosure assembly 120 by one or more connectors 179, such as welds, snaps, zippers, adhesives, solder, buttons, screws, nails, or any other type of connector known in the art.

5. Processor

Returning to FIG. 1f, a processor 176 is potentially any electrical or computer device capable of regulating the motors 164 of the vehicle assembly 150. The processor 176 receives, directly or indirectly, instructions 178 from a remote control unit 180.

C. Supplemental Components

FIG. 1h is a block diagram illustrating an example of the different types of components 180 that can serve as supplemental components for the apparatus.

1. Sensors

A sensor 184 is potentially any device that captures information. Many embodiments of the apparatus 100 will process sensor-captured information for the purposes of navigation, but there can be other purposes as well. For example, an apparatus 100 with a sensor 184 could be used to identify cracks in hard to reach infrastructure such as bridges, tall buildings, etc.

Examples of potentially relevant sensor types include cameras 185, microphones 186, GPS 190, and inertial measurement systems 182.

2. Antenna

An antenna 188 is a device that can assist in the transmission and receiving of communications and other forms of information.

3. Robotic Arm

A robotic arm 192, or other similar action-based component, can be controlled via remote control or can be programmed to act autonomously based on prior programming. Such an arm 192 can be retractable.

4. Storage Box

A storage box 194 is a container on the apparatus 100 that can be used to store and deliver a package. Some embodiments of the apparatus 100 can be used to deliver packages, supplies, medicines, etc. to recipients in hard to reach places.

### IV. Detailed Example of an Apparatus as a Whole

FIG. 2a is a perspective diagram illustrating an example of an apparatus 100. The apparatus in FIG. 2a is an example of quad-copter 160 embodiment of an air vehicle assembly 150 and a spherical 123 embodiment of an enclosure assembly 120.

There are four propellers 162 positioned in the same horizontal plane. Each propeller 162 has a motor 164 underneath it. There are eight vertical loops embodying 16 vertical enclosure members 132 and five horizontal loops embodying 10 horizontal enclosure members 134.

The shape of the apparatus 100 is spherical (or at least substantially spherical) and it has the capability to fly 112 in the air as well as to move 114 on the ground. All the movement functions can be controlled and operated remotely by using a remote control 99. A camera 185, and other sensors 184 as well as other supplemental components 180 can be embedded in the base 173 or on the base 173.

The apparatus 100 is safer than prior art drones. In a preferred embodiment, the enclosure assembly 120 is elastic or at least substantially elastic. Coupled with a rolling mode 116 that includes a substantial steering capability, damage to the apparatus 100 from bumps can be avoided.

The apparatus 100 can be easy way to land. It is possible to land in any attitude of the propellers plane since the enclosure assembly 120 protects and prevents the apparatus 100 from incurring harsh bumps.

During the take-off phase is possible to manually launch the quad-copter 160 and other embodiments of the apparatus 100 as a ball, with the user 98 throwing the apparatus 100 with their hands. This is possible because the enclosure assembly 120 prevents the hands of the user 98 from coming into contact with the propellers 162.

With a single apparatus 100 being able to move in two or more operating modes 110, the apparatus 100 can become a double-purpose device. The air and ground movement capabilities can provide unique opportunities not even thought up because the capability doesn't currently exist. One particular feature that could be quite valuable is the ability of the apparatus 100 to roll into a pipeline as part of the inspection process.

The rolling mode 116 can provide impressive speed and control capabilities. Prior art drones presently are controlled by a plane approach (roll, pich and yaw) that's because the drone identify a nose and wings are reference plane.

The spherical shape of the apparatus 100 can provide an entirely new way to pilot/control a drone. The apparatus 100 can be provided with a special sensor 184 that recognize in run-time the orientation of the remote control 99 with regards the orientation of the nose of the apparatus 100, so the user 98 does not have to refer to the nose drone direction to control it but just to the heading of the remote control 99 that is the user 98 orientations.

FIG. 2b is a top view diagram illustrating an example of the apparatus 100 displayed in FIG. 2a.

FIG. 2c is a bottom view diagram illustrating an example of the apparatus 100 displayed in FIGS. 2a and 2b.

FIG. 2d is a side view diagram illustrating an example of the apparatus 100 displayed in FIGS. 2a-2c.

### V. Enclosure Assembly

FIG. 3a is side view diagram illustrating an example of an enclosure assembly.

FIG. 3b is a side view diagram illustrating an example of an enclosure assembly.

FIG. 3c is a perspective view diagram illustrating an example of an enclosure assembly that is not curved.

### VI. Air Vehicle Assembly

FIG. 4a is a perspective view diagram illustrating an example of an air vehicle assembly.

FIG. 4b is a top view diagram illustrating an example of a frame.

FIG. 4c is a top view diagram illustrating an example of a frame.

FIG. 4d is a top view diagram illustrating an example of a frame.

FIG. 4e is a top view diagram illustrating an example of a frame.

FIG. 4f is a top view diagram illustrating an example of a frame.

FIG. 4g is a top view diagram illustrating an example of a frame.

FIG. 4h is a top view diagram illustrating an example of a frame.

### VII. Rolling Mode and Sterring

FIG. 5a is a top view diagram illustrating an example of an apparatus 100. The illustrated embodiment of the apparatus 100 is that of a quad-copter 160 in a substantially spherical enclosure assembly 123. The apparatus 100 includes both vertical enclosure members 132 and horizontal enclosure members 134. There are four propellers 162 illustrated in FIG. 5a. Those propellers are designated as P-1, P-2, P-3, and P-4.

A. Rolling Mode

FIG. 5b is a side view diagram illustrating an example of an apparatus 100 in a rolling operating mode 116. The air flows generated by P-1 and P-3 are directed upwards, while the air flows generated by P-2 and P-4 are directed downwards. The collective impact of those air flows causes the apparatus 100 to roll in a clockwise direction moving the apparatus 100 to the right as the rolling continues.

Put another way, torque is generated by applying opposite thrust in the propellers couples P-1/P-3 and P-2/P-4. To generate the rolling mode P-1 and P-3 have an opposite thrust of the P-2 and P-4. In this way it is possible to generate a torque, this torque will generate a rolling movement on the horizontal floor.

B. Steering While in Rolling Mode

FIG. 5c is a side view diagram illustrating an example of how an apparatus 100 can be steered while in a rolling mode 116. Magnitude differences in the upward airflows generated by P-1 and P-3 as well as the magnitude differences in the downward airflows generated by P-2 and P-4 can steer the apparatus 100 while it rolls along a ground or floor surface.

Put another way, for steering during the rolling mode 116 it is simple to unbalance the thrust generates by the propellers 162 on the same direction of the thrust (P1/P3 or P2/P4).

C. Process Flow Views

1. Flow Chart #1

FIG. 6a is a flow chart diagram illustrating an example of a rolling operating mode. Once a rolling mode 116 instruction effectuated by the apparatus 100, the apparatus 100 generates a downward airflow direction from one or more propellers 162 located at what is to the be direction of the movement of the apparatus 100 (the temporary “front” of the apparatus 100), and an upward airflow direction from one or more propellers 164 located at what is to be opposite to the direction of the movement of the apparatus 100 (the temporary “rear” of the apparatus 100). FIG. 6a corresponds to the illustration in FIG. 5b. While in rolling mode 116, the apparatus 100 can be steered as illustrated in FIG. 5c above.

As indicated in FIG. 6a, a two-propeller 162 embodiment of the apparatus 100 can implement a rolling mode 116 of movement. Only one propeller 162 at 200 is required for generating upward airflow and only one propeller 162 at 202 is required for generating downward airflow. Having four or more propellers 162 facilitates the ability to steer the apparatus 100 while in a rolling mode 116. If only two propellers 162 are present, steering would require some alternative mechanism or it is possible that a differentiation based on magnitude of the airflow could provide some steering capability.

During the propulsion of the apparatus 100 in a rolling mode 116, the apparatus 100 can use an inclinomenter and a gyro sensor system to control the propellers 162 dedicated to the propulsion in the rotation speed and direction by acting coordinated with the rolling mode 116. The motion controls needs to maintain stable the direction

2. Flow Chart #2

FIG. 6b is a flow chart diagram illustrating an example of an apparatus 100 switching back and forth between various operating modes 110.

At 210 the apparatus 100 is activated. In some embodiments this itself can be done remotely. In others, it requires the user 98 to be in the physical presence of the apparatus 100.

At 212 the apparatus 100 enters flying mode 112. This typically involves having all propellers 162 generating a downward airflow that lifts up the apparatus 100 into the air. Steering is achieved by differentiating the magnitude of the airflows at different positions in the apparatus 100.

At 214 the apparatus 100 enters a ground mode 114, such as a rolling mode 116. This should be done after the apparatus 100 is flown to the ground or close to the ground to prevent excessive bumping when the apparatus 100 touches the ground. In a rolling mode 116, some of the airflows generated by some of the propellers 162 will be in an upward direction.

At 216, the apparatus 100 can transition from ground mode 114 to flying mode 112. This typically involves having all airflows directed in a downwards direction. The transition from rolling mode 116 to flying mode 112 can be actuated by a command to fly. An inclinometer system in communication with the processor 176 can automatically recognize when the proper conditions exist to switch in the flying mode 112 (i.e. when the orientation of the propellers 162 plane is horizontal such that airflow in a downwards direction will left the apparatus 100 straight up). The apparatus 100 can be configured to not allow a transition from ground mode 114 to flying mode 112 unless the orientation of the apparatus 100 is suitable or at least acceptable. Once flight mode 112 has been successfully actuated, the control over the apparatus 100 is consistent with prior art approaches.

At 218, the apparatus 100 can transition back from a flying mode 112 to a ground mode 114, such as a rolling mode 114, as discussed above.

At 220, the apparatus 100 can be deactivated, powered down, etc. for the purposes of storage after its use is completed.

### VIII. Index of Elements

Table 1 below comprises an index of elements, element numbers, and element descriptions.

| Num- | Element | |
|---|---|---|
| ber | Name | Element Description |
| 98 | User | Human being or external computer system that |
| | | provides instructions 178 to the apparatus 100. |
| 99 | Remote | The apparatus 100 can be configured to perform pre- |
| | Control | programmed activities, including autonomous |
| | Unit | actions based on various algorithms, expert |
| | | systems, artificial intelligence, etc. The apparatus |
| | | 100 can also be configured to receive instructions |
| | | 178 remotely from a remote control unit 180. The |
| | | remote control unit 180 is not part of the |
| | | apparatus 100. The remote control unit 99 can also |
| | | be referred to as a controller 99. |
| 100 | Apparatus | An unmanned aerial vehicle (“UAE”). The |
| | | apparatus 100 can also referred to as a “drone” or |
| | | “drone apparatus”. The apparatus 100 includes an |
| | | enclosure assembly 120 that protects an air vehicle |
| | | assembly 150 positioned within the enclosure |
| | | assembly 120. The apparatus 100 is capable of |
| | | operating in more than one mode of transportation, |
| | | including a ground operating mode 114. The |
| | | apparatus 100 can be comprised of a wide variety |
| | | of materials, including but not limited to plastic, |
| | | metal, wood, ceramics, and other materials. |
| 110 | Operating | A mode of motion or transportation pertaining to the |
| | Mode | apparatus 100. The apparatus 100 can configured to |
| | | operate in two or more modes 110. |
| 112 | Flight/Flying | An operating mode 110 that involves flying through |
| | Mode | the air. Can also be referred to as a flying operating |
| | | mode 112. The apparatus 112 can include a variety |
| | | of different types of flying mode, some primarily |
| | | resembling helicopter flight, some primarily |
| | | resembling the flying mechanisms of an airplane, |
| | | and others embodying a hybrid approach. |
| 114 | Ground | An operating mode 110 that involves moving while |
| | Mode | substantially staying in contact with the ground. |
| 116 | Roll/Rolling | An operating mode 110 that involves the apparatus |
| | Mode | 100 rolling on the ground. A rolling mode 116 is an |
| | | example of a ground mode 114, and it is typically |
| | | but not always associated with a curve-shaped |
| | | enclosure assembly 122. |
| 120 | Enclosure | An air-permeable assembly that houses the air |
| | Assembly | vehicle assembly 150. The enclosure assembly |
| | | serves 150 to protect the air vehicle assembly |
| | | from the outside world, and the outside world from |
| | | the air vehicle assembly. The enclosure assembly |
| | | can also facilitate the ability of the apparatus to |
| | | roll 116, and other similar ground operating modes |
| | | 114. The enclosure assembly 120 can be comprised |
| | | of a wide variety of materials, but it is typically |
| | | advantageous to utilize a relatively elastic material |
| | | such polyvinyl chloride (“PVC”), polyethylene |
| | | (“PE”), polystyrene (“PS”), polypropylene |
| | | (“PP”), other types of general plastic, rubber, or |
| | | similar elastic or partially elastic materials. The |
| | | enclosure assembly 120 can also be referred to |
| | | simply as an enclosure 120. |
| 122 | Curved | An enclosure assembly 120 that possesses at least a |
| | Enclosure | curved shape. A curved shape can facilitate the |
| | Assembly | rolling mode 116 of a vehicle. |
| 123 | Spherical | An enclosure assembly 123 that is spherical or |
| | Enclosure | substantially spherical in shape. A spherical |
| | Assembly | enclosure assembly 123 is often highly desirable in |
| | | terms of providing users of the apparatus 100 with |
| | | adequate control and performance attributes in |
| | | multiple operating modes 110. |
| 124 | Oval | An enclosure assembly 124 that is ovular or |
| | Enclosure | substantially ovular in shape. |
| | Assembly | |
| 126 | Non-Curved | Many embodiments of the apparatus 100 can include |
| | Enclosure | an enclosure assembly 120 that does not include |
| | Assembly | curved edges. Examples of such embodiments |
| | | include icosahedrons, dodecagons, icosagons, |
| | | tricontagons, tetracontagons, penacontagons, |
| | | hexcontagons, and other known geometrical |
| | | configurations. |
| 130 | Enclosure | The enclosure assembly 120 can be comprised of |
| | Member | various enclosure members 130. Enclosure members |
| | | 130 can also be referred to as members 130. |
| 132 | Vertical | An enclosure member 130 that possesses a vertical |
| | Enclosure | or substantially vertical orientation within the |
| | Member | enclosure assembly 120. A vertical enclosure |
| | | member 132 can also be referred to a vertical |
| | | member 132. |
| 134 | Horizontal | An enclosure member 130 that possess a horizontal |
| | Enclosure | or substantially horizontal orientation within the |
| | Member | enclosure assembly 120. A horizontal enclosure |
| | | member 134 can also be referred to as a horizontal |
| | | member 134. |
| 136 | Opening | An area in the surface of the enclosure assembly 120 |
| | | that is air permeable. Openings 136 can be shaped in |
| | | a wide variety of different geometries and |
| | | configurations. In some embodiments, the openings |
| | | 136 are simply spaces between members 130 or |
| | | other totally vacant space in the surface of the |
| | | enclosure assembly 120. In other embodiments, |
| | | openings 136 are covered by a mesh 138. The |
| | | opening 136 can also be referred to as an |
| | | enclosure opening 136. |
| 138 | Mesh | A screen, filter, or similar material that covers the |
| | | opening 136 but nonetheless allows air to flow in |
| | | and out of the enclosure 120. |
| 150 | Vehicle | An assembly within the enclosure 120 that provides |
| | Assembly | the apparatus 100 with the capability to move. The |
| | | vehicle assembly 150 can be implemented in a |
| | | wide variety of different ways known in the prior |
| | | art. The vehicle assembly 150 can include virtually |
| | | any component or subassemblies known in the prior |
| | | art with respect to drone technology. Virtually any |
| | | type of air vehicle can benefit from being enclosed |
| | | in an enclosure assembly 120. The vehicle assembly |
| | | 150 can also be referred to as an air vehicle |
| | | assembly. |
| 160 | Quad-Copter | An embodiment of the vehicle assembly 160 that |
| | | involves a frame 170 and four propellers 162. In |
| | | some embodiments of a quad-copter 160, the four |
| | | propellers 162 are equidistant from each other and |
| | | positioned within the same horizontal plane and |
| | | pointing in the same direction. |
| 162 | Propeller | The apparatus 100 will include one or more |
| | | propellers 162. Many embodiments include four or |
| | | more propellers 162 because multiple propellers |
| | | can assist in steering the vehicle in various operating |
| | | modes 110. Some embodiments may include jet or |
| | | rocket propulsion for use in addition to propellers |
| | | 162 while in flight mode 112. |
| 164 | Motor | A motor 162 is a device that causes the propeller |
| | | 162 to turn. Virtually any motor 162 used for a |
| | | prior art drone can be incorporated as a motor 164 |
| | | for the apparatus 100. Multiple propeller 162 |
| | | embodiments will typically involve multiple |
| | | motors 164. |
| 165 | Brushless | Many embodiments of the apparatus 100 will |
| | Motor | include a motor 164 that is a brushless motor 165. |
| 166 | Power | A power source 166 is any source of energy that can |
| | Source | power the motor 164. Power sources can be batteries |
| | | 167 (of different types), solar cells, and other power |
| | | sources known in the prior art. |
| 167 | Battery | A battery 167 is a device that allows for energy to |
| | | be stored for future use. A wide variety of different |
| | | batteries 167 can be incorporated into the apparatus |
| | | 100. |
| 170 | Frame | A physical structure within the vehicle assembly 140 |
| | | that serves to secure the position of many other |
| | | components within the enclosure assembly 120. |
| 172 | Loop | A frame member 174 in the form curved loop. Some |
| | Member | embodiments of the air vehicle assembly 150 may |
| | | use a loop member 172 for structural support within |
| | | the enclosure assembly 120. |
| 173 | Base | A structure on the frame that can be used to support |
| | | various components on the air vehicle assembly 150. |
| | | Not all embodiments of the vehicle assembly 150 |
| | | will include a base 173. |
| 174 | Frame | A member within the frame 170. The frame 170 can |
| | Member | be embodied in a wide variety of different frame |
| | | member configurations 174. The frame member 174 |
| | | can also be referred to simply as a member 174. |
| 175 | Cross | A configuration of frame 170 in which frame |
| | Member | members 174 are positioned in a perpendicular |
| | | manner with respect to each other. |
| 176 | Processor | Any electrical or computer device capable of |
| | | regulating the motors 164 of the vehicle assembly |
| | | 150. The processor 176 receives, directly or |
| | | indirectly, instructions 178 from a remote control |
| | | unit 180. |
| 178 | Instructions | The apparatus 100 can be configured to perform pre- |
| | | programmed activities, including autonomous |
| | | actions based on various algorithms, expert systems, |
| | | artificial intelligence, etc. The apparatus 100 can |
| | | also be configured to receive instructions 178 |
| | | remotely from a remote control unit 180. The |
| | | remote control unit 180 is not part of the |
| | | apparatus 100. |
| 179 | Connectors | The frame 170 can be temporarily or permanently |
| | | secured in the proper position within the enclosure |
| | | assembly 120 by one or more connectors 179, such |
| | | as welds, snaps, zippers, adhesives, solder, buttons, |
| | | screws, nails, or any other type of connector known |
| | | in the art. |
| 180 | Supple- | An optional component of the apparatus 100 that |
| | mental | performs a specific function. Examples of |
| | Components | supplemental components includes inertial |
| | | measurement systems 182, sensors 184 such as |
| | | cameras 185 and microphones 186, antenna 188 to |
| | | facilitate communication between the apparatus 100 |
| | | and external communication points, GPS 190, |
| | | robotic arms 192, lockable storage boxes 194, and |
| | | virtually any other component that can be built |
| | | into the apparatus 100 to serve a particular |
| | | use or need. |
| 182 | Inertial | An inertial measurement system can assist the |
| | Measure- | processor 176 in implementing the transition |
| | ment | between different operating modes 110 as well |
| | System | as other motion/position control functions. |
| 184 | Sensor | A sensor 184 is potentially any device that captures |
| | | information. |
| 185 | Camera | A camera 185 is a sensor 184 that captures visual |
| | | information, either as still frame images and/or as |
| | | video. |
| 186 | Microphone | A microphone is a sensor 184 that captures sound. |
| 188 | Antenna | An antenna is a device that can assist in the |
| | | transmission and receiving of communications and |
| | | other forms of information. |
| 190 | GPS | A global positioning system (“GPS”) can assist the |
| | | apparatus 100 in navigation. |
| 192 | Robotic | A robotic arm 192can be controlled via remote |
| | Arm | control or can be programmed to act autonomously |
| | | based on prior programming. |
| 194 | Storage | A container on the apparatus 100 that can be used to |
| | Box | store and deliver a package. |

### IX. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

The apparatus 100 can be implemented in a wide variety of different ways using a wide variety of different materials, geometric shapes, and operating configurations. The apparatus 100 is conceptually broad enough to incorporate virtually any type of UAV capable of being partially, substantially, or fully enclosed in an enclosure assembly 120.

1. A drone apparatus (100), comprising:
an enclosure assembly (120); and
an air vehicle assembly (150) securely positioned within said enclosure assembly (120);
wherein said drone apparatus (100) provides for operating in a plurality of modes (110), said plurality of modes (110) including a flight mode (112) and ground mode (114).

2. The drone apparatus (100) of claim 1, wherein said ground mode (114) is a rolling mode (116).

3. The drone apparatus (100) of claim, said drone apparatus further comprising a processor (176) that provides for receiving an instruction (178) from a remote control unit (99).

4. The drone apparatus (100) of claim 1, wherein said enclosure assembly (120) includes:
a plurality of enclosure members (130); and
a plurality of enclosure openings (136);
wherein said enclosure assembly (120) is a substantially spherical enclosure assembly (123).

5. The drone apparatus (100) of claim 2, wherein said plurality of enclosure members (130) includes a plurality of horizontal enclosure members (134) and a plurality of vertical enclosure members (132), and wherein said plurality of enclosure openings (136) are filled by a plurality of air-permeable mesh surfaces (138).

6. The drone apparatus (100) of claim 1, wherein said ground mode (114) is a rolling mode (116).

7. The drone apparatus (100) of claim 1, wherein said air vehicle assembly (150) is a quad-copter air vehicle (160).

8. The drone apparatus (100) of claim 1, wherein said air vehicle assembly (150) includes a plurality of propellers (162) located within the same horizontal plane.

9. The drone apparatus (100) of claim 1, wherein said air vehicle assembly (150) includes a plurality of propellers (162) and a frame (170), wherein said propellers (162) are attached to said frame (170), and wherein a plurality of connectors (178) connect said frame (170) to said enclosure assembly (120).

10. The drone apparatus (100) of claim 1, wherein said air vehicle assembly (150) includes:
a frame (170), said frame comprising a plurality of frame members (174);
a plurality of propellers (162) positioned on said plurality of frame members (174);
a base (173) positioned one or more said frame members (174);
wherein said plurality of propellers (162) are each positioned facing upwards from said plurality of frame members (174) when said apparatus (100) is positioned on a bottom (102) of said apparatus (100).

11. The drone apparatus (100) of claim 11, wherein said at least one said propeller (162) directs air upwards and at least one said propeller (162) directs air downwards when said drone apparatus (100) is a ground operating mode (114).

12. The drone apparatus (100) of claim 11, said drone apparatus (100) further comprising an inertial measurement system (182), a camera (185), an antenna (188), and a GPS device (190).

13. A drone apparatus (100), comprising:
an enclosure assembly (120), wherein said enclosure assembly is a substantially spherical enclosure assembly (123) that includes a plurality of surfaces (135) and a plurality of openings (136);
an air vehicle assembly (150), said air vehicle assembly (150) including a frame (170) securely attached to the interior of said enclosure assembly (120), said air vehicle assembly (150) further including a plurality of propellers (162) and a plurality of motors (164) securely positioned on said frame (170);
wherein said drone apparatus (100) provides for operating in a plurality of operating modes (110), said plurality of modes including a flying mode (112) and a rolling mode (116).

14. The drone apparatus (100) of claim 13, wherein said plurality of surfaces (135) in said substantially spherical enclosure assembly (123) is comprised of substantially elastic material, wherein said air vehicle assembly (150) includes at least four propellers (162) positioned within the same horizontal plane and facing the same direction.

15. A method for operating a drone apparatus (100) that that provides for operating in plurality of modes (110) that includes a ground mode (114), wherein said drone apparatus (100) includes a plurality of propellers (162), said method comprising:
selectively reversing air flow direction for at least one said propeller (162) when said drone apparatus (100) is in a ground mode (114).

16. The method for operating a drone apparatus (100) of claim 15, wherein said ground mode (114) provides for rolling said drone apparatus (100) on an exterior surface.

17. The method for operating a drone apparatus (100) of claim 15, wherein said drone apparatus (100) includes at least four said propellers (162), said method comprising selectively reversing said air flow direction for at least two said propellers (162) when said drone apparatus (100) is in a ground mode (114).

18. The method for operating a drone apparatus (100) of claim 15, said method further comprising:
receiving an instruction (178) from a remote control unit (99); and
changing said operation mode (110) in accordance with said instruction (178).

19. The method for operating a drone apparatus (100) of claim 15, said method further comprising:
changing from a flying operating mode (112) to a rolling operating mode (116) by reversing the airflow of at least one propeller (162).

20. The method for operating a drone apparatus (100) of claim 15, wherein said drone apparatus (100) includes an air vehicle assembly (160) that includes at least four propellers (162), and wherein the airflow for more than one adjacent propellers (160) are reversed to change into a rolling operating mode (116).
